(19) United States
(12) Patent Application Publication
(10) Pub. No.: US 2010/0214441 A1
(43) Pub. Date: Aug. 26, 2010

(54) IMAGING APPARATUS

(76) Inventors: Takashi Yanada, Hachioji-shi (JP); Akira Ueno, Hachioji-shi (JP)

Correspondence Address: Straub & Pokotylo, 788 Shrewsbury Avenue, Tinton Falls, NJ, 07724, US

(21) Appl. No.: 12/687,023

(22) Filed: Jan. 13, 2010

(30) Foreign Application Priority Data
Feb. 24, 2009 (JP) 2009-041327

(51) Int. Cl. H04N 5/76

(52) U.S. Cl. 348/231.2; 348/E05.031

(57) ABSTRACT

An imaging apparatus includes an imaging unit, a first storage unit, and a smoothing unit. The imaging unit outputs an image signal. The first storage unit stores the image signal. The smoothing unit performs a smoothing of causing the first storage unit to store a predetermined amount of the image signal uniformly on time within a horizontal scanning period in which the predetermined amount of the image signal is output from the imaging unit.

### CROSS-REFERENCE TO RELATED APPLICATIONS

This application is based upon and claims the benefit of priority from prior Japanese Patent Application No. 2009-041327, filed Feb. 24, 2009, the entire contents of which are incorporated herein by reference.

### BACKGROUND OF THE INVENTION

1. Field of the Invention

The present invention relates to an imaging apparatus, and particularly to a technique for improving efficiency of processing for outputting an image signal in an imaging apparatus.

2. Description of the Related Art

In recent years, operating speeds of imaging elements have been increasing higher. With increase in operating speeds of imaging elements, a greater number of images can be picked up in a short period. Increase in number of continuously acquired images is accompanied by increase in number of images to be processed by an image processing unit in a later step.

A processing flow from imaging by an imaging element to image processing by an image processing unit will now be described in brief. An image signal input from an imaging element is subjected to preprocessing such as digitization by a preprocessing unit. Imaging data obtained through the preprocessing by the preprocessing unit is each time retained in a buffer memory in a bus interface connected to a bus. When a predetermined amount of imaging data is retained in the buffer memory, a transfer request for transferring imaging data is issued from the bus interface to the bus. In response to the transfer request, an acknowledgement is issued. Then, the imaging data retained in the buffer memory in the bus interface is written to a storage unit such as a DRAM through the bus. Thereafter, the imaging data stored in the storage unit is read out by an image processing unit, and is then subjected to various image processing. The imaging data is further written back to the storage unit. An image written back to the storage unit is displayed on a predetermined display unit or recorded onto a predetermined recording medium.

In a series of processing for causing the display unit to sequentially display continuously acquired images on the display unit, the bus is controlled to transfer, with highest priority, imaging data which is input from the preprocessing unit. Unless imaging data from the preprocessing unit is transferred with priority, real-time display cannot be achieved. Therefore, the image processing unit is capable of accessing the storage unit through the bus only in a period in which no transfer request for transferring imaging data is issued from the preprocessing unit to the bus.

In general, image signals from an imaging element are sequentially input to the preprocessing unit in synchronization with a horizontal synchronization signal, as disclosed in Jpn. Pat. Appin. KOKAI Publication No. 2001-203925. However, a part of a horizontal scanning period is a blanking period in which no image signal effective for display and recording purposes is input. During the blanking period, no transfer request for transferring imaging data is issued from a preprocessing unit to a bus, and therefore, an image processing unit is capable of accessing a storage unit.

### BRIEF SUMMARY OF THE INVENTION

A first aspect of the invention, there is provided an imaging apparatus comprising: an imaging unit that outputs an image signal; a first storage unit that stores the image signal; and a smoothing unit that performs a smoothing of causing the first storage unit to store a predetermined amount of the image signal uniformly on time within a horizontal scanning period in which the predetermined amount of the image signal is output from the imaging unit.

Advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram representing a configuration of an example of an imaging apparatus according to a first embodiment of the invention;

FIG. 2 is a diagram representing a configuration of a preprocessing unit;

FIG. 3 is a chart expressing a concept of smoothing processing;

FIG. 4 is a diagram representing an interior configuration of the smoothing unit according to the first embodiment of the invention;

FIG. 5 is a timing chart expressing operation of the smoothing unit represented in FIG. 4;

FIG. 6A expresses an example of a read pattern;

FIG. 6B expresses operation of the smoothing unit in case where the read pattern of FIG. 6A is set;

FIG. 7 is a diagram representing an interior configuration of a smoothing unit according to a second embodiment of the invention;

FIG. 8 is a timing chart expressing operation of a smoothing unit represented in FIG. 7;

FIG. 9 is a diagram representing an interior configuration of a smoothing unit according to a third embodiment of the invention;

FIG. 10 is a timing chart expressing operation of the smoothing unit represented in FIG. 9; and

FIG. 11 represents a configuration of an imaging element according to a fourth embodiment of the invention.

### DETAILED DESCRIPTION OF THE INVENTION

Hereinafter, an embodiment of the present invention will be described with reference to the drawings.

### First Embodiment

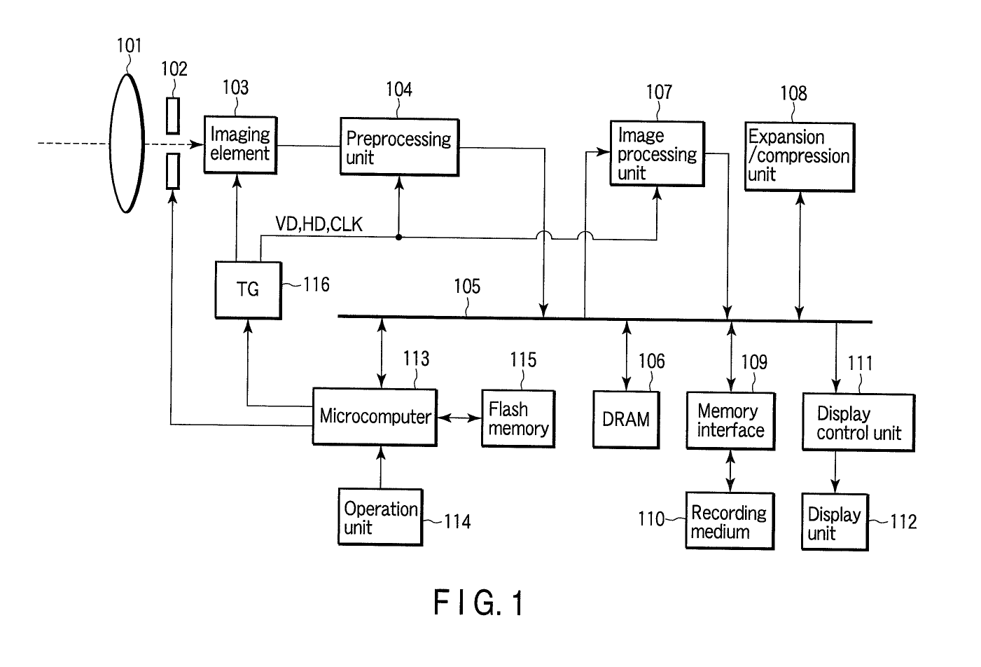

At first, the first embodiment of the invention will now be described below. FIG. 1 is a diagram representing a configuration of an example of an imaging apparatus according to the first embodiment of the invention. The imaging apparatus represented in FIG. 1 includes a lens 101, a shutter diaphragm 102, an imaging element 103, a preprocessing unit 104, a bus 105, a DRAM 106, an image processing unit 107, a compression/expansion processing unit 108, a memory interface 109, a recording medium 110, a display control unit 111, a display unit 112, a microcomputer 113, an operation unit 114, a flash memory 115, and a timing generator (TG) 116.

The lens 101 converges an optical image of a subject onto an imaging element 103. The shutter diaphragm 102 is provided near the lens 101. The shutter diaphragm 102 is a diaphragm which adjusts an incident amount of light from the lens 101 to the imaging element 103 under control of the microcomputer 113, and also serves as a shutter. Of course, a shutter and a diaphragm may be provided as separate members.

The imaging element 103 includes a light receiving surface where photoelectric transducers such as photodiodes are two-dimensionally arrayed. The imaging element 103 converts light converged by the lens 101 into electrical signals (image signals), and outputs the electrical signals to the preprocessing unit 104. The imaging element 103 may be of a CMOS method or CCD method.

The imaging element 103 recognizes start of an output processing for outputting image signals for one frame (or one field) depending on a vertical synchronization signal VD from the TG 116. After inputting of the vertical synchronization signal VD, the imaging element 103 performs an output processing for outputting image signals of a predetermined amount (e.g., for one line) each time the horizontal synchronization signal HD is input from the TG 116. At this time, the imaging element 103 outputs the predetermined amount of image signals, sequentially for one after another one of pixels, in synchronization with a clock signal CLK from the TG 116. In the description below, a period in which an output processing for outputting the predetermined amount of image signal will be referred to as a horizontal scanning period.

After performing various preprocessing on the image signals from the imaging element 103, the preprocessing unit 104 transfers a digital image signal (hereinafter imaging data) which is obtained by the preprocessing, to the DRAM 106 through the bus 105. The preprocessing in the preprocessing unit 104 are performed in synchronization with the vertical synchronization signal VD, horizontal synchronization signal HD, and clock signal CLK from the TG 116.

The bus 105 is a transfer path for transferring various data generated inside the imaging apparatus to respective blocks in the imaging apparatus. The bus 105 is connected to the preprocessing unit 104, DRAM 106, image processing unit 107, compression/expansion processing unit 108, memory interface 109, display control unit 111, and microcomputer 113. If a transfer request for transferring data is issued to the bus 105, the bus 105 transfers data, depending on predetermined priorities.

The DRAM 106 which functions as a first storage unit stores imaging data obtained by the preprocessing unit, and various data such as imaging data processed by the image processing unit 107 and the compression/expansion processing unit 108.

The image processing unit 107 performs various image processing such as a white balance correction processing and a noise reduction processing on imaging data which is read from the DRAM 106 through the bus 105. The image processing unit 107 stores processed imaging data in the DRAM 106 through the bus 105. Processing in the image processing unit 107 are performed in synchronization with the vertical synchronization signal VD, horizontal synchronization signal HD, and clock signal CLK from the TG 116.

The compression/expansion processing unit 108 reads imaging data processed by the image processing unit 107, from the DRAM 106 through the bus 105, and compresses the read imaging data in accordance with, for example, a JPEG method. Further, when reproducing the imaging data, the compression/expansion processing unit 108 reads compressed imaging data recorded on the recording medium 110 through the bus 105, and expands the read imaging data.

The memory interface 109 controls writing and reading of imaging data to and from the recording medium 110. The recording medium 110 is, for example, a memory card which is attachable to and detachable from the imaging apparatus. Compressed imaging data is recorded on the recording medium 110 by the compression/expansion processing unit 108.

The display control unit 111 reads imaging data from the DRAM 106, and converts the imaging data into a video signal. The display control unit 111 outputs the converted video signal to the display unit 112, and displays images on the display unit 112. The display unit 112 is, for example, a TFT liquid crystal display, and displays images based on the video signal from the display control unit 111.

The microcomputer 113 totally controls various sequences for a digital camera. The microcomputer 113 is connected to the operation unit 114 and flash memory 115.

The operation unit 114 includes various operation members for allowing a user to operate the imaging apparatus represented in FIG. 1. As the user operates the operation members of the operating unit 114, the microcomputer 113 executes various sequences according to user's operation. The flash memory 115 stores various parameters required for operating the imaging apparatus. The flash memory 115 also stores various programs which are executed by the microcomputer 113. In accordance with programs stored in the flash memory 115, the microcomputer 113 reads parameters required for various sequences from the flash memory 115 and performs various processing.

The TG 116 generates signals (e.g., the vertical synchronization signal VD, horizontal synchronization signal HD, and clock signal CLK) for controlling operation timings of the preprocessing unit 104 and image processing unit 107, in accordance with a control signal from the microcomputer 113.

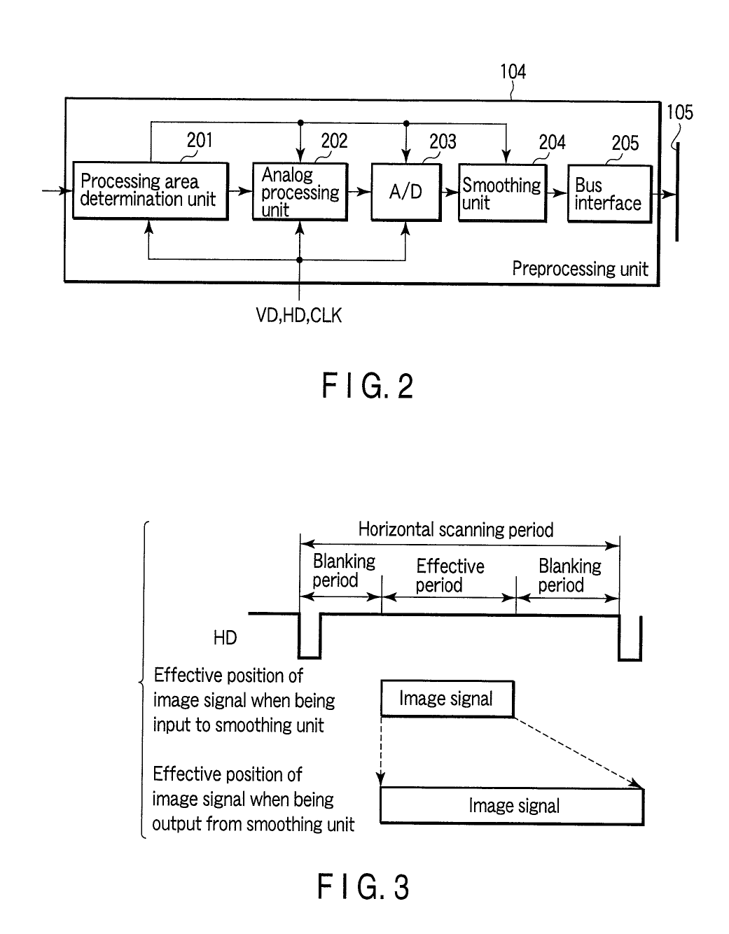

FIG. 2 is a diagram representing a configuration of the preprocessing unit 104. In addition to the processing described above for generating imaging data, the preprocessing unit 104 according to this embodiment performs a processing (hereinafter referred to as a smoothing processing) for smoothing input of imaging data from the preprocessing unit 104 to the bus 105 so that the input may not be concentrated on a particular period within a horizontal scanning period.

The preprocessing unit 104 represented in FIG. 2 includes a processing area determination unit 201, an analog processing unit 202, an analog/digital conversion unit (A/D) 203, a smoothing unit 204, and a bus interface 205.

The processing area determination unit 201 determines a position of an image signal to be preprocessed within an image signal input from the imaging element 103. Usually, image signals from all pixels in the imaging element cannot be subjected to display or recording. For example, commonly, the imaging element is provided with pixels shielded from light, named “optical black”. The “optical black” refers to pixels each of which outputs an image signal equivalent to a dark current component. By subtracting the image signals equivalent to the dark current component from other image signals, dark current noise can be removed from the image signals. Such optical black image signals are not used for display or recording. Further, pixels outside an image circle of the lens 101 are not used for display or recording. The processing area determination unit 201 is provided for determining, as a position of an image signal to be preprocessed, a position of an effective image signal usable for display and recording. A signal indicating an effective position of an image signal, which is determined by the processing area determination unit 201, is input to the analog processing unit 202, analog/digital conversion unit 203, and smoothing unit 204.

The analog processing unit 202 performs analog processing such as a correlative double sampling (CDS) processing and an automatic gain control (AGC) processing on an image signal corresponding to an effective position determined by the processing area determination unit 201. The analog processing unit 202 performs an analog processing on the image signal in synchronization with the clock signal CLK. The CDS processing is to subtract image signals from optical black pixels from image signals input through the processing area determination unit 201. The AGC processing is to amplify image signals in compliance with an analog/digital conversion range of the analog/digital conversion unit 203.

The analog/digital conversion unit 203 generates imaging data of a digital signal by converting the image signal corresponding to the effective position determined by the processing area determination unit 201. The analog/digital conversion unit. 203 is to perform an analog/digital conversion processing on the image signal in synchronization with the clock signal CLK.

The smoothing unit 204 smoothes the smoothing processing described previously. The smoothing processing of the smoothing unit 204 will be described later.

The bus interface 205 includes a buffer memory capable of storing imaging data corresponding to effective positions which are sequentially input from the smoothing unit 204. Each time imaging data is stored in the buffer memory, the bus interface 205 issues, to the bus 105, a transfer request for transferring imaging data. If transfer is allowed by the bus 105, the bus interface 205 inputs imaging data to the bus 105.

Next, the smoothing processing will be described below. FIG. 3 is a chart expressing a concept of the smoothing processing. As has been described previously, for example, image signals equivalent to one line are sequentially input to the preprocessing unit 104 from the imaging element 103 in a horizontal scanning period. Further, the image signals input to the preprocessing unit 104 are sequentially processed by the analog processing unit 202 and analog/digital conversion unit 203, and then input to the smoothing unit 204.

As has been described previously, all image signals from the imaging element 103 cannot be subjected to display and recording but only a part of the all image signals can be used for display and recording. Now, an effective period is assumed to be a period in which image signals corresponding to effective positions image signals from which can be used for display and recording are output from the imaging element 103. Then, the effective period is usually concentrated on a part of a horizontal scanning period, as represented in FIG. 3. In other part of period than the effective period, ineffective image signals which cannot be used for display or recording are input or no image signals are input at all. In general, this period is referred to as a blanking period.

In the smoothing processing, a processing is performed to make a read speed (read data rate) of reading imaging data from the smoothing unit 204 (SRAM 301) to the bus interface 205 slower relative to a write speed (write data rate) of writing imaging data to the smoothing unit 204 (SRAM 301) from the analog/digital conversion unit 203. In this manner, imaging data is input to the bus interface 205 uniformly on time during the horizontal scanning period. By performing the processing described above, imaging data is input to the bus interface 205 even during the blanking period, and accordingly, the amount of imaging data which is input to the bus interface 205 during the effective period is reduced accordingly. As a result, a period in which imaging data corresponding to effective positions is input to the bus interface 205 is not concentrated on any part of the horizontal scanning period. Therefore, an interval at which a transfer request for the bus 105 from the bus interface 205 can be widened. As a result, the band of the bus 105 can be effectively used.

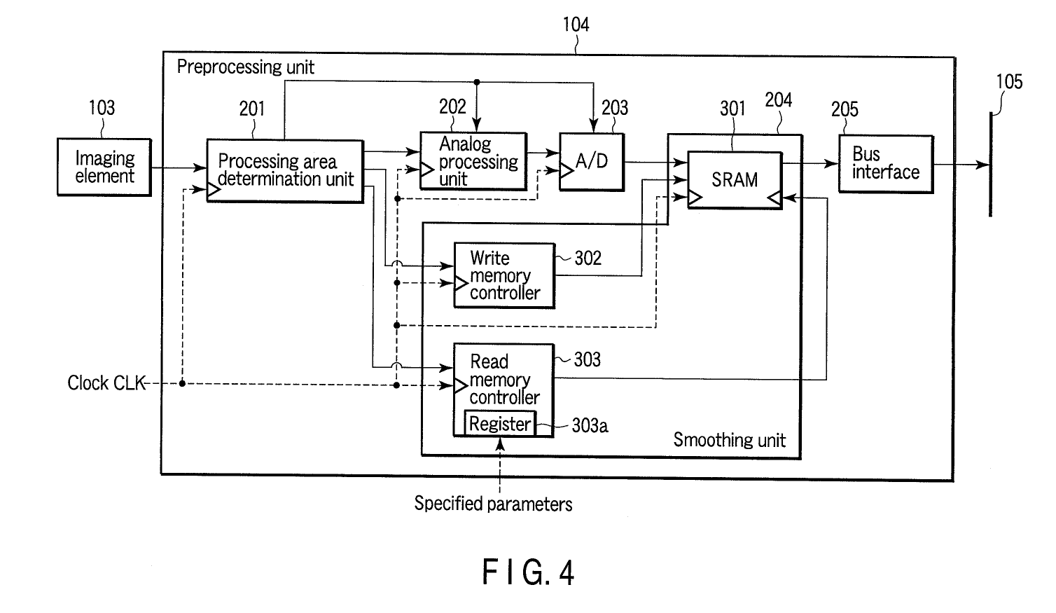

Next, a specific configuration of the smoothing unit 204 will be described. FIG. 4 is a diagram representing an interior configuration of the smoothing unit 204 in the first embodiment. The smoothing unit 204 represented in FIG. 4 includes a SRAM 301, a write memory controller 302, and a read memory controller 303.

The SRAM 301 which functions as a second storage unit stores imaging data corresponding to effective positions, which are obtained by the analog/digital conversion unit 203. When a memory write signal from the write memory controller 302 becomes enabled, imaging data from the analog/digital conversion unit 203 is then written to the SRAM 301. When a memory write signal from the read memory controller 303 becomes enabled, imaging data written in the SRAM 301 is then read out through the bus interface 205. Although a SRAM is used as the second storage unit in this case, a line memory may be used as an alternative.

The write memory controller 302 which functions as a write control unit controls writing of imaging data to the SRAM 301 by making the memory write signal enable or disable in synchronization with the clock signal CLK. In the write memory controller 302, a write pattern is set such that imaging data is written to the SRAM 301 once for each one input of the clock signal. CLK. In other words, the memory write signal becomes enabled one for each one clock.

The read memory controller 303 which functions as a read control unit controls reading of imaging data from the SRAM 301 by making the memory read signal enable or disable in synchronization with the clock signal CLK. The read memory controller 303 according to this embodiment includes a register 303a for setting a read pattern. The read pattern can be changed by the microcomputer 113. The read memory controller 303 switches the read signal between enable and disable in accordance with a read pattern which is preset in the register 303a. The read pattern is set in a manner that “1” indicating enabling of reading and “0” indicating disabling of reading are arrayed in a predetermined pattern in the register 303a. At this time, the read pattern is set such that imaging data is read from the SRAM 301 once for plural inputs of the clock signal CLK, i.e., the memory read signal is enabled once for plural inputs of the clock signal CLK. Further, at this time, the read pattern is determined in a manner that reading of imaging data corresponding to effective positions is finished before a timing of starting writing of imaging data in a next horizontal scanning period.

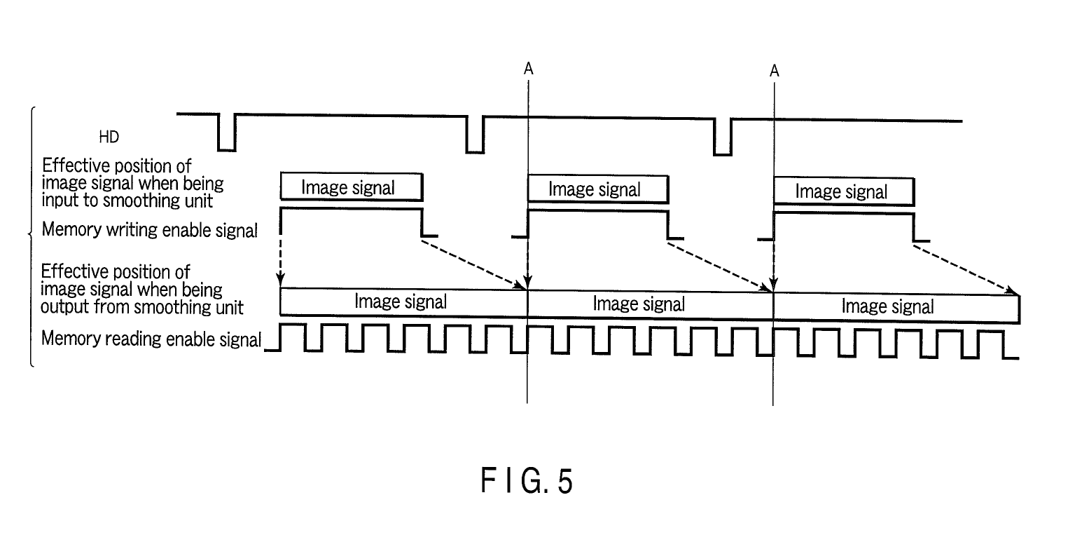

FIG. 5 is a timing chart expressing conceptual operation of the smoothing unit represented in FIG. 4.

As represented in FIG. 5, an effective part of the image signal output from the imaging element 103 is only a part (effective period) of a horizontal scanning period. The write memory controller 302 switches the memory write signal between enable and disable so that imaging data corresponding to effective positions is written to the SRAM 301 once for each one clock.

On the other side, a read pattern is set in the read memory controller 303 such that imaging data is read from the SRAM 301 once for each of plural clocks. In accordance with the read pattern, the memory write signal is switched between enable and disable. As has been described previously, reading of imaging data corresponding to effective positions is finished before a timing (denoted at timing A in the figure) of starting writing imaging data in a next horizontal scanning period.

As has been described above, according to the first embodiment, the read speed (read data rate) of reading imaging data from the smoothing unit 204 is set slower relative to the write speed (write data rate) of writing imaging data to the smoothing unit 204, as expressed in FIG. 5. In this manner, the period in which imaging data is input to the bus interface 205 can be extended. Accordingly, the period in which the bus interface 205 accesses the bus 105 is not concentrated on a particular period. Therefore, the band of the bus 105 is not pressed in a particular period or no useless margin is created in the band of the bus 105 outside such a particular period. In this manner, use efficiency of the bus 105 can be improved.

The smoothing processing will now be described in more details. In the example described above, the read pattern is set such that reading is performed once for plural inputs of the clock signal. In actual, however, the read pattern may be set such that reading is performed a number of times for plural inputs of the clock signal provided that the aforementioned number of times is smaller than the number of plural inputs and such that reading of imaging data corresponding to effective positions is finished before start of writing imaging data in a next horizontal scanning period.

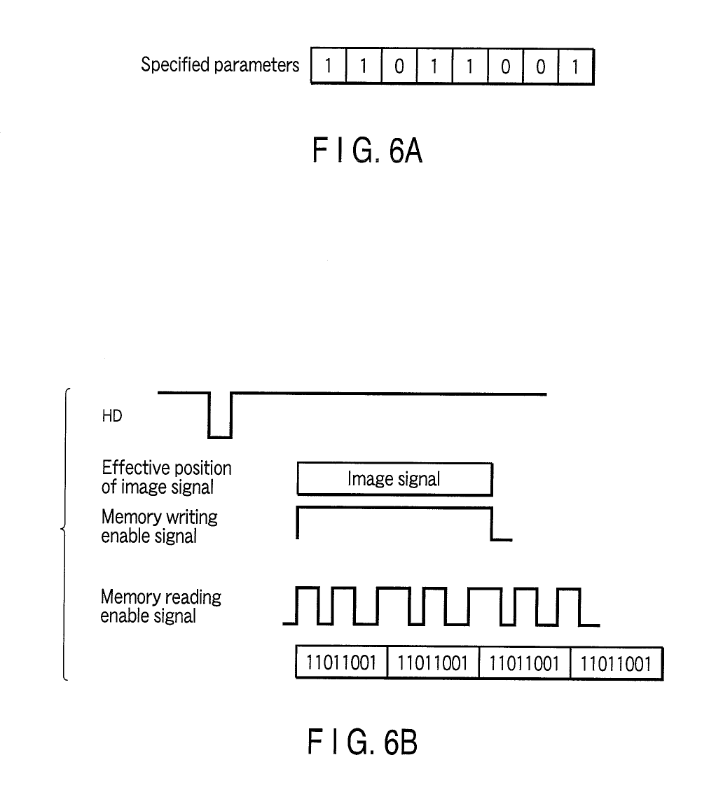

For example, the read pattern for the read memory controller 303 may be set as expressed in FIG. 6A. FIG. 6A expresses an example of setting a read pattern in an 8-bit register wherein “1” indicates enabling of reading and “0” indicates disabling of reading. FIG. 6A expresses an example of setting in an 8-bit register. Insofar as the bit number is 2 or more, the bit number of the register is not particularly limited.

In the read pattern in FIG. 6A, reading is performed five times for each eight inputs of the clock signal. In this manner, the read data rate is ⅝ of the write data rate shown in FIG. 6B.

By setting a read pattern as expressed in FIG. 6A, a fine read pattern can be set. As a result, the band of the bus 105 can be controlled finely.

The smoothing processing described in this embodiment is particularly preferably practiced at the time of through-image display (a processing of displaying images obtained by continuous acquisition operation of the imaging element 103 on the display unit 112) and at the time of capturing a video. In general, in the through-image display or when capturing a video, images of higher resolution than in capturing still images are not required. Therefore, in the through-image display and when capturing a video, reading is performed culling image signals from a part of pixels of the imaging element 103. In case of performing such culling, effective positions of image signals are concentrated on a much limited part of the horizontal scanning period. Therefore, use efficiency of the bus 105 can be improved by performing the smoothing processing. For example, at the time of the through-image display, other processing such as face detection than a through-image display processing is performed. Therefore, not only the through-image display processing but also other processing can be achieved with higher efficiency by improving use efficiency of the bus 105. Further, if the smoothing processing is performed only at the time of through-image display or capturing a video, capacity of the SRAM 301 can be reduced.

### Second Embodiment

Next, the second embodiment of the invention will be described. The second embodiment relates to a modification to the smoothing processing.

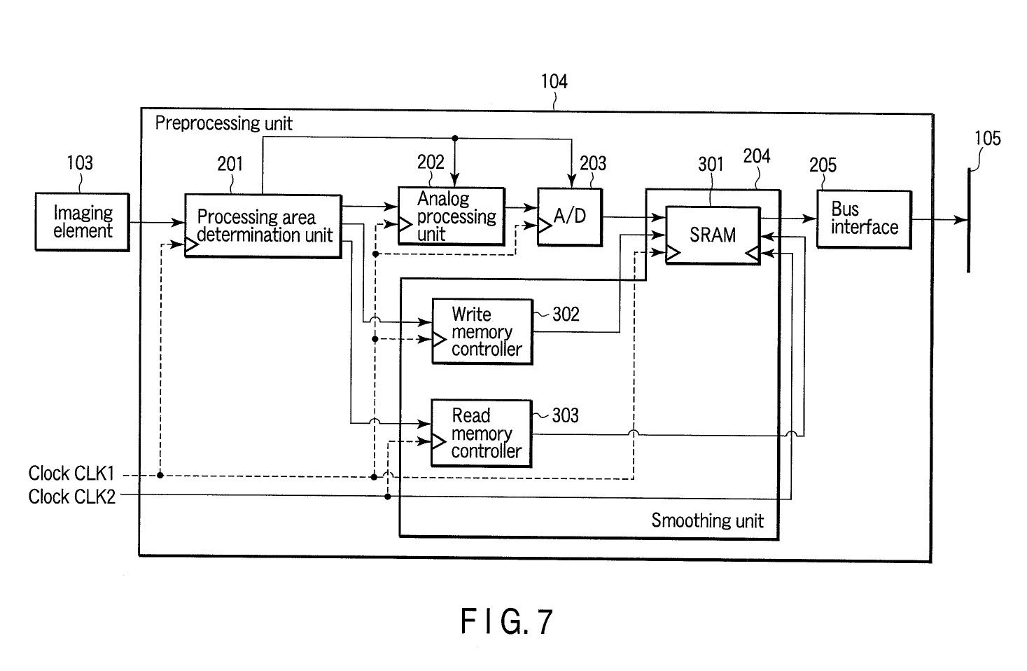

FIG. 7 is a diagram representing an interior configuration of a smoothing unit 204 according to the second embodiment. In FIG. 7, the same parts of the configuration as those in FIG. 4 are denoted at the same reference symbols as in FIG. 4. The second embodiment differs from the first embodiment in that a clock signal CLK2 which is slower than a clock signal CLK1 input to a write memory controller 302 is input to a read memory controller 303 and in that a fixed read pattern is used. A clock signal from a TG 116 may be directly used as clock signal CLK1. Clock signal CLK2 may be generated by dividing the clock signal CLK from the TG 116. A relationship in speed between clock signal CLK1 and clock signal CLK2 is determined by a length of a horizontal scanning period and a length of an effective period. Specifically, frequency of clock signal CLK2 needs to be smaller than (Valid/HD) of frequency of clock signal CLK1 provided that the length of the horizontal scanning period is expressed as HD and the length of the effective period is expressed as Valid.

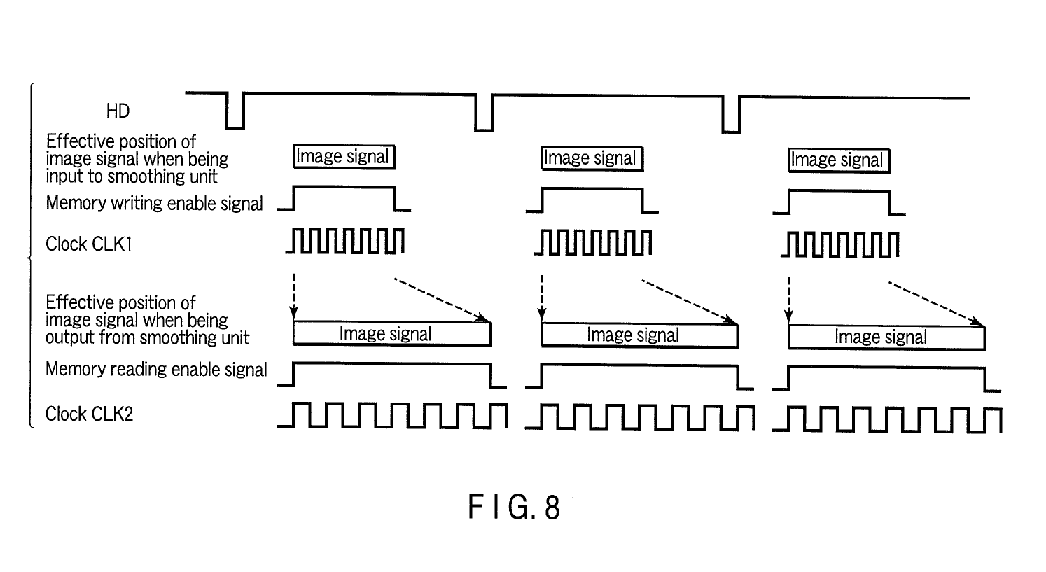

FIG. 8 is a timing chart expressing operation of the smoothing unit represented in FIG. 5.

As expressed in FIG. 8, an effective part of an image signal output from an imaging element 103 corresponds to only a part (effective period) of a horizontal scanning period. The write memory controller 302 switches a memory write signal between enable and disable so that imaging data corresponding to effective positions is written to an SRAM 301 once for each one input of clock signal. CLK1, in accordance with a signal indicating an effective position of the image signal from a processing area determination unit 201.

On the other side, the read memory controller 303 switches a memory read signal between enable and disable so that imaging data is read from the SRAM 301 once for each one input of clock signal CLK2, in accordance with a signal form the processing area determination unit 201, indicating an effective position of the image signal. At this time, reading of imaging data corresponding to effective positions is finished before a timing of starting writing of imaging data in a next horizontal scanning period, as in the first embodiment.

Clock signal CLK2 is a clock signal which is slower relative to clock signal CLK1. Therefore, a read data rate of reading from the smoothing unit 204 can be slower relative to a write data rate of writing to the smoothing unit 204 as in the first embodiment. In this manner, the second embodiment is also capable of improving use efficiency of the bus 105, as in the first embodiment.

### Third Embodiment

Next, the third embodiment of the invention will be described. The third embodiment relates to an example of combining methods according to the first and second embodiments.

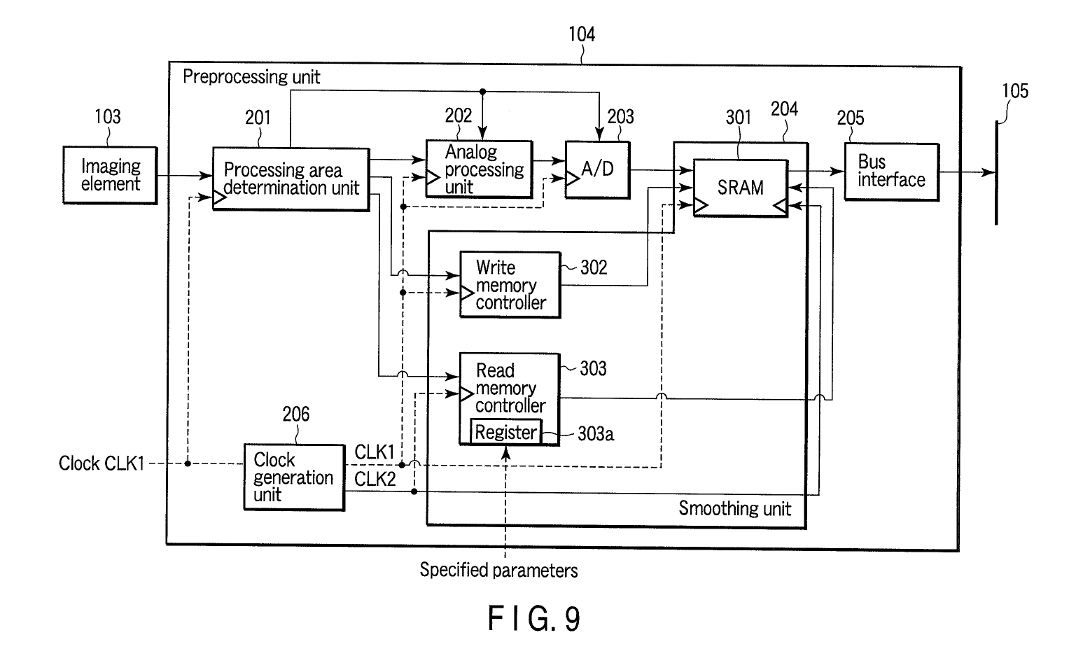

FIG. 9 is a diagram representing an interior configuration of a smoothing unit 204 according to the third embodiment. The third embodiment differs from the first and second embodiments in that a clock signal. CLK2 which has a different speed from that of a clock signal CLK1 input to a write memory controller 302 is input to a read memory controller 303. Although details will be described later, clock signal CLK2 may be either faster or slower than clock signal CLK1, according to the third embodiment.

In the example of FIG. 9, a clock generation unit 206 is provided. The clock generation unit 206 is to generate clock signals CLK1 and CLK2 by dividing a clock signal CLK. In place of using such a clock generation unit 206, the clock signal CLK for a TG 116 may be used as clock signal CLK1, and an operation clock for the bus 105 may be used as clock signal CLK2.

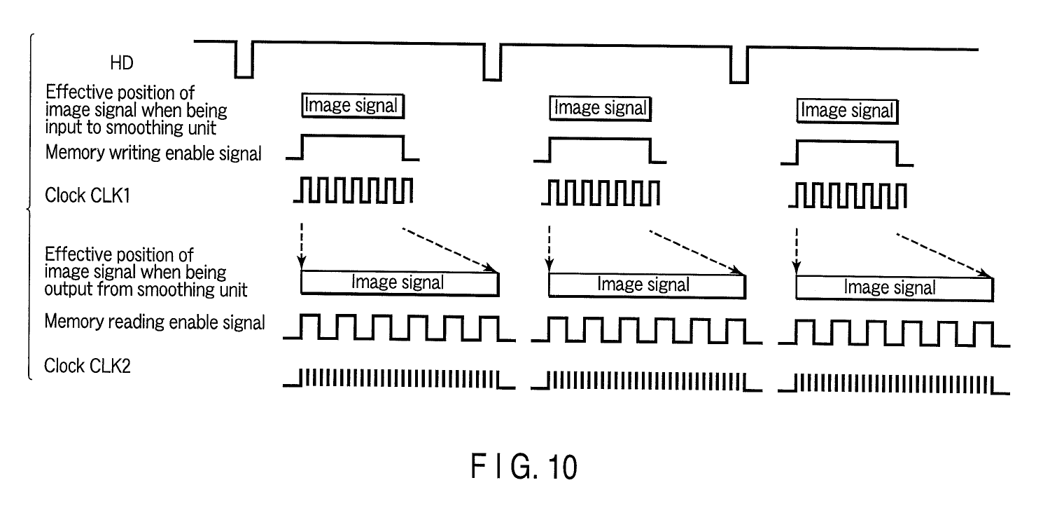

FIG. 10 is a timing chart expressing operation of the smoothing unit represented in FIG. 9. The example of FIG. 10 relates to a case that a faster clock signal than clock signal CLK1 is used as clock signal CLK2.

As represented in FIG. 10, an effective part of an image signal output from an imaging element 103 corresponds to only a part (effective period) of a horizontal scanning period. The write memory controller 302 switches a memory write signal between enable and disable so that imaging data corresponding to effective positions is written to an SRAM 301 once for each one input of clock signal CLK1, in accordance with a signal indicating an effective position of the image signal from a processing area determination unit 201.

On the other side, a read pattern is set in the read memory controller 303 such that imaging data is read from the SRAM 301 a number of times for plural inputs of clock signal CLK2. In accordance with the read pattern, the read memory controller 303 switches a memory read signal between enable and disable. If a faster clock signal than clock signal CLK1 is used as clock signal CLK2, the number of “0 (disabling of reading)” may be increased to be greater relative to the number of “1 (enabling of reading)” in the read pattern set in the register 303a, than in the first embodiment.

Unlike in the second embodiment, clock signal CLK2 is faster compared with clock signal CLK1. However, as in the first and second embodiments, the read data rate can be slower than the write data rate by reducing the number of times for which imaging data is read, in accordance with the method of the first embodiment. In this manner, use efficiency of the bus 105 can be also improved in the third embodiment. Further, the band of the bus 105 can be controlled more finely by combinational use of the first and second embodiments than by single use of each of the methods according to the first and second embodiments.

In the example described above, clock signal CLK2 is faster than clock signal CLK1. However, clock signal CLK2 may be slower than clock signal CLK1. In this case, the number of “0 (enabling of reading)” relative to the number of “1 (disabling of reading)” in the read pattern set in the register 303a may be increased to be greater compared with the first embodiment.

### Fourth Embodiment

Next, the fourth embodiment of the invention will be described. In recent years, an imaging element which integrates an analog processing unit and an analog/digital conversion unit has been proposed. The fourth embodiment relates to an example of integrating a smoothing unit with such an imaging element which already integrates an analog/digital conversion unit and an analog/digital conversion unit.

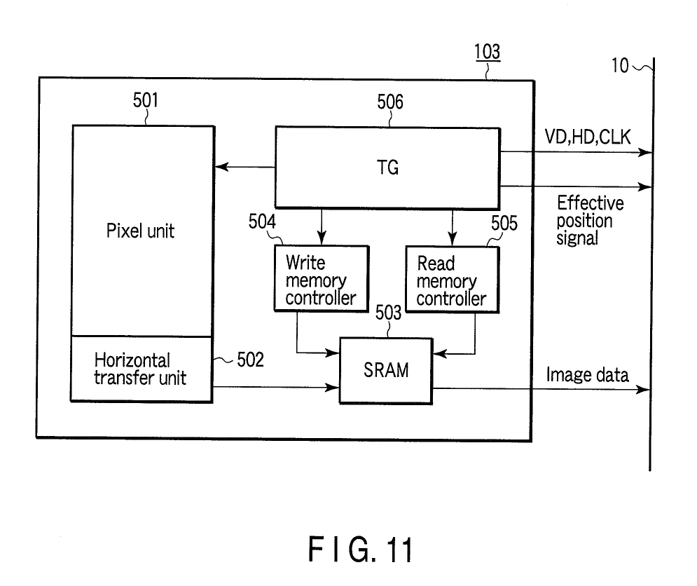

FIG. 11 is a diagram representing a configuration of an imaging element 103 according to the fourth embodiment. The imaging element 103 represented in FIG. 11 includes a pixel unit 501, a horizontal transfer unit 502, a SRAM 503, a write memory controller 504, a read memory controller 505, and a timing generator (TG) 506. The imaging element 103 represented in FIG. 11 is connected to a bus 105 through no preprocessing unit 104.

A light receiving surface and a preprocessing unit are mounted, mixed together, on the pixel unit 501. The light receiving surface is configured by two-dimensionally arraying photoelectric conversion elements such as photodiodes. The preprocessing unit includes an analog processing unit and an analog/digital conversion unit. The pixel unit 501 operates in accordance with a clock signal from the TG 506. The analog processing unit performs a CDS processing and an AGC processing on an image signal of an effective part of image signals which are obtained from the light receiving surface of the pixel unit 501. The analog/digital conversion unit obtains imaging data by performing an analog/digital conversion processing on image signals of effective positions which have been subjected to an analog processing by the analog processing unit.

The horizontal transfer unit 502 transfers imaging data obtained from the pixel unit 501 to the SRAM 503 in accordance with the clock signal from the TG 506 to the SRAM 503.

The SRAM 503, write memory controller 504, and read memory controller 505 constitute a smoothing unit as described in the foregoing first to third embodiments. That is, a smoothing processing is performed by decreasing a read data rate of reading imaging data from the SRAM 503 to the bus 105 by the read memory controller 505 to be slower relative to a write data rate of writing imaging data from the horizontal transfer unit 502 to the SRAM 503 by the write memory controller 504. Any of methods described in the foregoing first to third embodiments is available as a specific method for the smoothing processing. Therefore, description of such methods will be omitted herefrom.

The TG 506 generates signals (a vertical synchronization signal VD, a horizontal synchronization signal HD, and a clock signal CLK) for controlling operation timings of the preprocessing unit in the pixel unit 501 and an image processing unit 107. The TG 506 inputs the generated vertical synchronization signal VD, horizontal synchronization signal HD, and clock signal CLK to the pixel unit 501, write memory controller 504, read memory controller 505, and image processing unit 107 which is provided outside the imaging unit 103. The TG 506 also functions as a processing area determination unit 201 as described previously, and determines an effective position for an image signal obtained from the pixel unit 501. The TG 506 inputs a signal indicating a determined effective position signal, to the pixel unit 501, write memory controller 504, read memory controller 505, and image processing unit 107. Since the TG 506 is provided, the TG 116 represented in FIG. 1 is not required.

As has been described above, according to the fourth embodiment, a smoothing processing can be performed even in a configuration in which a smoothing processing unit and a preprocessing unit are mounted mixed together.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An imaging apparatus comprising:
an imaging unit that outputs an image signal;
a first storage unit that stores the image signal; and
a smoothing unit that performs a smoothing of causing the first storage unit to store a predetermined amount of the image signal uniformly on time within a horizontal scanning period in which the predetermined amount of the image signal is output from the imaging unit.

2. The imaging apparatus according to claim 1, wherein the smoothing unit comprises:
a second storage unit that stores the image signal output from the imaging unit;
a write control unit that performs control of writing of the image signal from the imaging unit to the second storage unit; and
a read control unit that performs control of reading of the image signal from the second storage unit to the first storage unit, at a read speed which is slower than a write speed of writing the image signal to the second storage unit under control of the write control unit.

3. The imaging apparatus according to claim 2, wherein the write control unit performs the control of writing of the image signal once per one input of a first clock signal, and performs the control of reading of the image signal a number of times per a plurality of inputs of a second clock signal, the number of times being smaller than a number of the plurality of inputs.

4. The imaging apparatus according to claim 3, wherein the read control unit comprises a register that sets a read pattern used for performing the control of reading of the image signal the number of times per the plurality of inputs of the second clock signal, the number of times being smaller than the number of the plurality of inputs.

5. The imaging apparatus according to claim 3, wherein the first clock signal and the second clock signal have respectively different speeds.

6. The imaging apparatus according to claim 2, wherein the write control unit performs the control of writing of the image signal once per one input of a first clock signal, and performs the control of reading of the image signal once per one input a second clock signal which is slower than the first clock signal.

7. The imaging apparatus according to claim 1, wherein the smoothing unit is integrated with the imaging unit.

8. The imaging apparatus according to claim 2, wherein the smoothing unit is integrated with the imaging unit.

9. The imaging apparatus according to claim 3, wherein the smoothing unit is integrated with the imaging unit.

10. The imaging apparatus according to claim 1, wherein the smoothing unit performs the smoothing when the imaging apparatus captures a video or performs through-image display.

11. The imaging apparatus according to claim 2, wherein the smoothing unit performs the smoothing when the imaging apparatus captures a video or performs through-image display.

12. The imaging apparatus according to claim 3, wherein the smoothing unit performs the smoothing when the imaging apparatus captures a video or performs through-image display.

13. The imaging apparatus according to claim 4, wherein the smoothing unit performs the smoothing when the imaging apparatus captures a video or performs through-image display.

14. The imaging apparatus according to claim 5, wherein the smoothing unit performs the smoothing when the imaging apparatus captures a video or performs through-image display.

15. The imaging apparatus according to claim 6, wherein the smoothing unit performs the smoothing when the imaging apparatus captures a video or performs through-image display.

16. The imaging apparatus according to claim 7, wherein the smoothing unit performs the smoothing when the imaging apparatus captures a video or performs through-image display.

17. The imaging apparatus according to claim 8, wherein the smoothing unit performs the smoothing when the imaging apparatus captures a video or performs through-image display.

18. The imaging apparatus according to claim 9, wherein the smoothing unit performs the smoothing when the imaging apparatus captures a video or performs through-image display.
